(19) United States
(12) Patent Application Publication
(10) Pub. No.: US 2016/0292281 A1
(43) Pub. Date: Oct. 6, 2016

(54) OBTAINING CONTENT BASED UPON ASPECT OF ENTITY

(71) Applicant: Microsoft Technology Licensing, LLC, Redmond, WA (US)

(72) Inventors: Anitha Kannan, Saratoga, CA (US); Abhimanyu Das, San Jose, CA (US)

(21) Appl. No.: 14/676,304

(22) Filed: Apr. 1, 2015

(51) Int. Cl. G06F 17/30

(52) U.S. Cl. CPC G06F 17/30867; G06F 17/30528; G06F 17/30401

(57) ABSTRACT

One or more systems and/or techniques are provided for obtaining content based upon an aspect of an entity. An entity aspect evaluation model is trained based upon burstiness, diversity, and/or uniqueness indicator information for a phrase as relates to an entity, which indicates how likely the phrase is an aspect of the entity (e.g., how likely an “engine fire recall” phrase is as an aspect of a sports car entity). Phrases within social network data (e.g., microblog messages) are evaluated utilizing the trained entity aspect evaluation model to identify whether such phrases are aspects of the entity. Responsive to determining that a phrase is an aspect of the entity, content is obtained (e.g., search results are provided) based upon the aspect. Because the content is obtained based upon a phrase from social network data, the content may pertain to a fresh or trending topic (e.g., due to current social commentary).

### BACKGROUND

Many users may utilize social networks to discover and share information with other users. In an example, a user may create a social network post “I just had the best time at Water Park XYZ” to share with social network friends. In another example, the user may share a photo of a sports car at a car dealership in order to obtain opinions from social network friends about the sports car. In another example, the user may read social network posts about a new videogame console release in order to make a videogame console purchase decision. In this way, users may share commentary about entities, such as companies, consumer products, public figures, sports teams, and/or other people, places, and/or things, through social networks.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for obtaining content based upon an aspect of an entity are provided herein. In an example, social network data is accessed to identify a phrase. The phrase is evaluated utilizing an entity aspect evaluation model to determine a feature indicator for the phrase. The feature indicator comprises at least one of a burstiness indicator, a diversity indicator, or a uniqueness indicator for the phrase as relates to an entity. The feature indicator is evaluated to determine an aspect score for the phrase. A determination is made as to whether the phrase is an aspect of the entity based upon the aspect score. Responsive to determining that the phrase is an aspect of the entity, content is obtained based upon the aspect.

In an example, an entity, for which an entity aspect evaluation model is to be trained, is identified. Labeled training data, comprising labels for phrases associated with the entity, are obtained. The labeled training data is utilized to train the entity aspect evaluation model for feature indicator evaluation of phrases. The entity aspect evaluation model is trained based upon burstiness indicator information, diversity indicator information, and/or uniqueness indicator information for a phrase as relates to the entity. Content is obtained based upon an aspect of the entity, where the aspect is identified using the entity aspect evaluation model to evaluate a first phrase associated with the entity.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method for obtaining content based upon an aspect of an entity.

FIG. 2 is a component block diagram illustrating an exemplary system for obtaining content based upon an aspect of an entity.

FIG. 3 is a component block diagram illustrating an exemplary system for obtaining content based upon an aspect of an entity.

FIG. 4 is a flow diagram illustrating an exemplary method for obtaining content based upon an aspect of an entity.

FIG. 5 is a component block diagram illustrating an exemplary system for obtaining content based upon an aspect of an entity.

FIG. 6 is an illustration of an example of aspects identified for an entity.

FIG. 7 is an illustration of an exemplary computer readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

Conventional techniques for obtaining and/or providing content lack consideration of certain indicators such as burstiness, diversity, and/or uniqueness, such as derived from social network data or social commentary. Search results or other content provided without considering one or more of such indicators and/or correlation(s) between such indicators may be less than optimal (e.g., stale, off topic, etc.), which may result in users performing additional searches thereby exacerbating computing resource and network bandwidth utilization. Accordingly, as provided herein one or more of such indicators and/or correlation(s) there-between are considered such that content (e.g., search results) provided to users is reflective of user commentary (e.g., social network activity regarding trending and/or popular topics, etc.), which mitigates computing resource and/or network bandwidth utilization by providing desired information to users more quickly (e.g., with fewer query iterations). Resource conservation may be significant as many content providers utilize substantial amounts of computing resources and network bandwidth in an attempt to identify information that may be relevant to users. For example, a search engine provider may employ a significant amount of hardware, such as servers, that may be used to identify content sources, retrieve content from the content sources, evaluate the content, and/or provide the content to users of a search engine hosted by the search engine provider. Thus, reducing iterations, directing searches to particular content sources, etc. may result in significant savings.

As provided herein, burstiness, diversity, and/or uniqueness indicators are considered when providing content by using an entity aspect evaluation model trained with data that is a function of such indicators. The entity aspect evaluation model is trained using labeled training data comprising phrases having labels indicative of whether a phrase is an aspect of an entity (e.g., a very high likelihood that an “engine fire recall” phrase is as an aspect of a sports car entity). The labels applied to the phrases in the labeled training data are a function of burstiness, diversity, and/or uniqueness indicators and/or correlation(s) there-between relative to an entity such that, once trained, the entity aspect evaluation model may be used to evaluate a phrase (e.g., from social network data) to determine whether the phrase is an aspect of the entity (e.g., a low likelihood that a “poor gas mileage” phrase is an aspect of the sports car entity).

When a phrase is determined to be an aspect of an entity (e.g., there is a likelihood above some threshold that the phrase is an aspect of the entity), the aspect can be said to have a sufficient degree of correlation with the entity such that interest in the entity may translate or be imputed to interest in the aspect and vice versa (e.g., content obtained based upon the aspect and/or the entity may pertain to the entity and/or the aspect). Accordingly, a more temporally relevant, etc. response to a request for content for the entity may include not only content for the entity but may also include content for the aspect as well. Similarly, a more temporally relevant, etc. response to a request for content for the aspect may include not only content for the aspect but may also include content for the entity as well. For example, a web search for a sports car entity may return content corresponding to both the sports car entity and an “engine fire recall” phrase where the phrase is determined to be an aspect of the sports car entity. Similarly, a web search for an “engine fire recall” phrase may return content corresponding to both the “engine fire recall” phrase and a sports car entity where the phrase is determined to be an aspect of the sports car entity. A user may thus be less inclined to submit subsequent or multiple requests for content because the user is initially provided with the information that the user is seeking, which in turn mitigates computing resource and/or network bandwidth utilization.

Using the entity aspect evaluation model allows social network data to be efficiently harnessed or mined to obtain relevant content (e.g., fresh, trending, popular, etc.), where social network data may otherwise be difficult to evaluate due to noise (e.g., social network posts may be short, informal, lack context and/or structure, etc.), redundancy (e.g., redundant social networks posts of promotional campaigns soliciting users to repost a promotion campaign post that is not indicative of aspects of an entity), and/or ambiguity in user social network posts. In this way, the entity aspect evaluation model may allow content providers to efficiently identify aspects of an entity so that such content providers may provide relevant content (e.g., search results, advertisements, recommendations, etc.) and/or perform business analytics (e.g., adjust marketing campaigns, identify trends, identify consumer opinions on consumer products, etc.) while consuming less processing power and/or network bandwidth.

In an example, a device (e.g., a content provider server) may host a modeling training component, configured to train the entity aspect evaluation model, and an aspect determination component configured to use the entity aspect evaluation model to determine whether a phrase is an aspect of an entity. In another example, a first device (e.g., a model training server) may host the modeling training component configured to train the entity aspect evaluation model, and a second device (e.g., the content provider server) may comprise the aspect determination component configured to use the entity aspect evaluation model to determine whether a phrase is an aspect of an entity. In another example, at least some of the modeling training component and/or the aspect determination component may be implemented on a single device or across one or more devices.

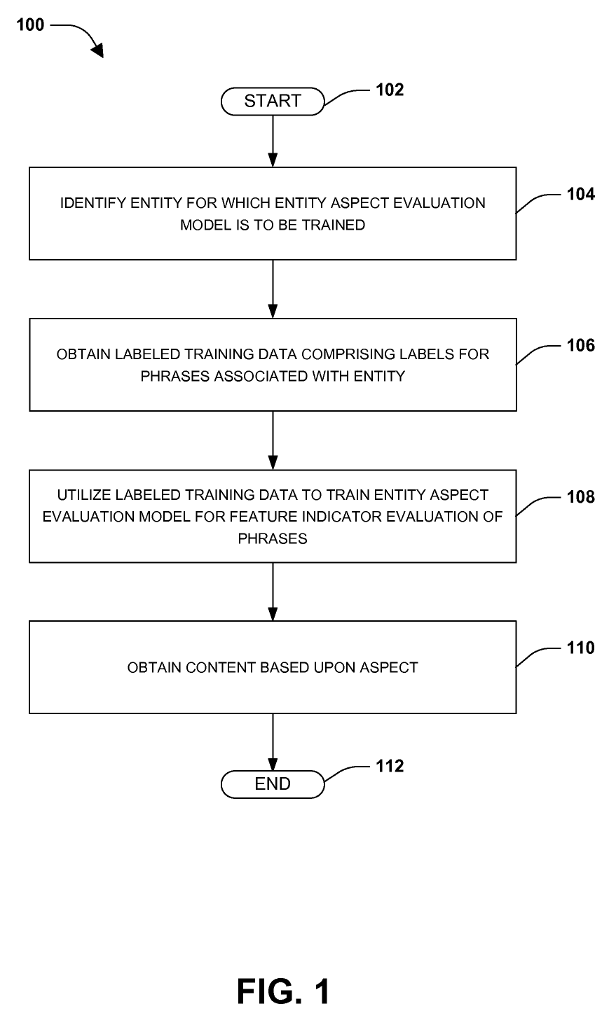

An embodiment of obtaining content based upon an aspect of an entity is illustrated by an exemplary method 100 of FIG. 1. At 102, the method starts. At 104, an entity, for which an entity aspect evaluation model is to be trained, may be identified. The entity may correspond to a consumer product, a person, a business, a social issue, a place, an organization, and/or any other item that may be discussed by users. The entity aspect evaluation model may be trained for a sports car entity, for example. At 106, labeled training data, comprising labels for phrases associated with the entity, may be obtained. In an example, phrases may be labeled as whether they are an aspect for the entity by leveraging web search result data (e.g., to obtain noisy training labels). For example, a phrase (e.g., a candidate phrase such as an “engine fire recall” phrase) may be submitted as a query to a search engine. Responsive to a threshold percentage of search results comprising the phrase and the entity, the phrase may be labeled as an aspect for the entity (e.g., the “engine fire recall” phrase may be labeled as an aspect for the sports car entity if at least about 10% of about the top 50 search results comprise the sports car entity and the “engine fire recall” phrase (e.g., or variation(s) thereof)). Otherwise, the phrase may be labeled as a non-aspect for the entity. In this way, a set of phrases may be created for inclusion within the labeled training data.

At 108, the labeled training data may be utilized to train (e.g., utilizing an Expectation-Maximization algorithm) the entity aspect evaluation model for feature indicator evaluation of phrases associated with the entity (e.g., trained for subsequent evaluation of phrases within social network data in order to determine aspects of the entity). The entity aspect evaluation model may be trained to identify a correlation between burstiness indicator information, diversity indicator information, and uniqueness indicator information for a phrase.

The burstiness indicator information may correspond to an increase in phrase usage within a threshold timespan (e.g., a spike in usage of the “engine fire recall” phrase over a time period may indicate that the “engine fire recall” phrase is more likely an interesting aspect in general and thus may likely be an aspect of the sports car entity, whereas a static or substantially constant usage or occurrence of the “engine fire recall” phrase over the period of time may indicate that the “engine fire recall” phrase is less likely to be an interesting aspect in general and thus may be less likely to be an aspect of the sports car entity). The diversity indicator information may correspond to a number of diverse social network posts comprising a phrase (e.g., discussion of the “engine fire recall” phrase in numerous diverse social network posts may indicate that the “engine fire recall” phrase is more likely an interesting aspect in general and thus may likely be an aspect of the sports car entity, whereas merely a high frequency of reposts of the “engine fire recall” phrase (e.g., correspond to a promotion that solicits users to repost to win a prize) may indicate that the “engine fire recall” phrase is less likely to be an interesting aspect in general and thus may be less likely to be an aspect of the sports car entity). In an example, locality sensitive hashing may be performed to compute hash fingerprints of social network posts comprising a phrase. A subset of social network posts whose fingerprints are different (e.g., a largest subset) may be used to identify a diversity indicator. The uniqueness indicator information may correspond to a difference between overall usage of a phrase (e.g., the usage of the “engine fire recall” phrase in all social network posts) and entity related usage of the phrase (e.g., the usage of the “engine fire recall” phrase in social network posts related to the sports car entity). The more the phrase is used in entity related usage compared to overall usage, the more likely the phrase is to be an aspect of the entity (e.g., if 65% of all social network posts use the “engine fire recall” phrase in association with the sports car entity, then the “engine fire recall” phrase is likely to be an aspect of the sports car entity, but if merely 1% of all social network posts use the “engine fire recall” phrase in association with the sports car entity, then the “engine fire recall” phrase is not likely an aspect of the sports car entity). In this way, the entity aspect evaluation model may be trained to evaluate such indicators when evaluating social network and/or other data to determine one or more aspects of an entity.

Certain indicators may provide relatively more accurate indications of whether a particular phrase is an aspect of an entity as compared to other indicators. In an example regarding a global warming entity, a “volcanic eruptions” phrase may have burstiness because the “volcanic eruptions” phrase might be rarely used with regard to the global warming entity until an eruption occurs and thus a spike in usage may occur, a “tornado season” phrase may be diverse but not bursty because the “tornado season” phrase may be regularly discussed with regard to the global warming entity, etc. Accordingly, the entity aspect evaluation model may be trained to identify weights for indicators on a per-phrase basis. For example, the entity aspect evaluation model may be trained to identify a first weight for a burstiness indicator, a second weight for a diversity indicator, and a third weight for a uniqueness indicator, which may be used when evaluating a particular phrase such as the “engine fire recall” phrase in association with the sports car entity. Different weights may be assigned to the indictors for other phrases in association with the sports car entity, such as a “200 mph top speed” phrase.

In an example, the labeled training data may be utilized to cluster phrases having similar indicator weights. A first cluster of phrases, having a first distribution of burstiness indicator information, diversity indicator information, and/or uniqueness indicator information above a similarity threshold, may be identified (e.g., burstiness and uniqueness, but not diversity, may be relatively more accurate indications of whether phrases in the first cluster of phrases are aspects of the sports car entity). A second cluster of phrases, having a second distribution of burstiness indicator information, diversity indicator information, and/or uniqueness indicator information above the similarity threshold, may be identified (e.g., diversity and uniqueness, but not burstiness, may be relatively more accurate indications of whether phrases in the second cluster of phrases are aspects of the sports car entity). In this way, the entity aspect evaluation model may be trained for evaluating phrases within social network and/or other data to determine whether such phrases are aspects of an entity.

At 110, responsive to determining that first phrase is an aspect of the entity (e.g., the “engine fire recall” phrase is an aspect of the sports car entity), content is obtained based upon the aspect. For example, responsive to a search query associated with the entity, search results comprising content associated with the aspect are returned (e.g., in addition to content associated with the entity). In an example, at least some of a content provider (e.g., a server that may provide content through emails, a website, a search engine, an application, a map interface, a recommendation service, etc.) may be local to and/or remote from a user device and may provide content (e.g., that is temporally relevant, etc.) to the user device based upon the aspect of the entity. In an example, a search is directed towards content sources associated with the aspect of the entity to obtain relevant content, and thereby conserve resources. At 112, the method ends.

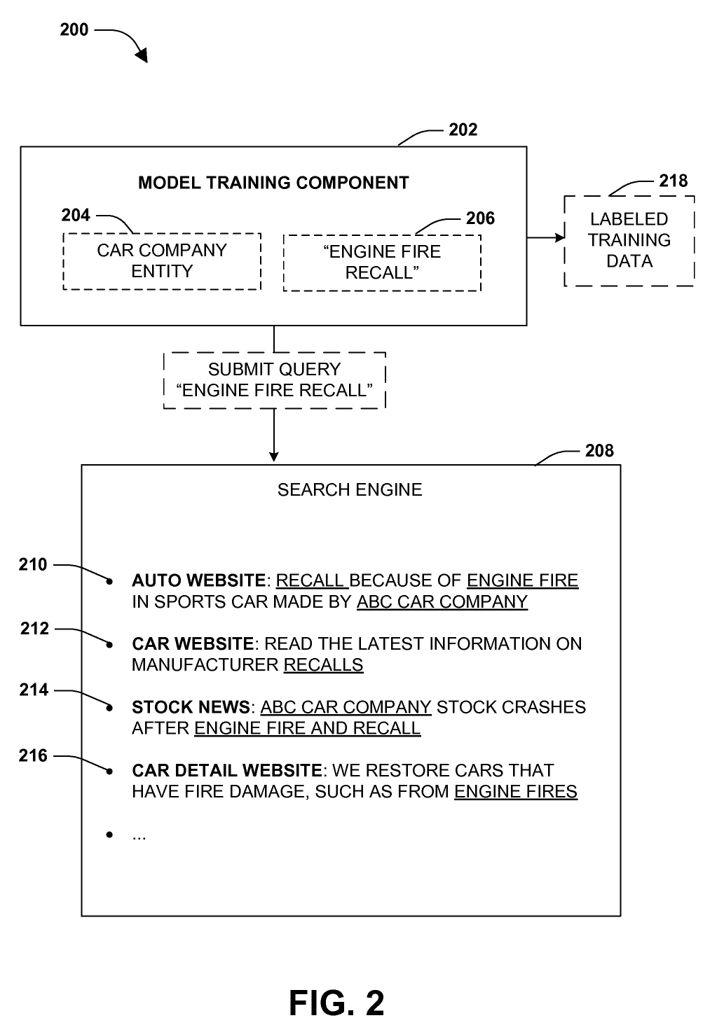

FIG. 2 illustrates an example of a system 200 for obtaining content based upon an aspect of an entity. The system 200 comprises a model training component 202. The model training component 202 may be configured to train an entity aspect evaluation model for an entity, such as a car company entity 204. The model training component 202 may obtain labeled training data 218 used to train the entity aspect evaluation model by submitting queries to a search engine 208 for labeling such queries as either aspects or non-aspects of the car company entity 204. For example, the model training component 202 may evaluate an “engine fire recall” phrase 206 to determine whether the “engine fire recall” phrase 206 is an aspect or a non-aspect of the car company entity 204. The model training component 202 may submit a query “engine fire recall” to the search engine 208. The search engine 208 may provide search results, such as an auto website search result 210, a car website search result 212, a stock news search result 214, a car detail website search result 216, and/or other search results not illustrated.

The model training component 202 may label the “engine fire recall” phrase 206 as an aspect of the car company entity 204 based upon a threshold percentage of the search results comprising the “engine fire recall” phrase 206 and the car company entity 204 and/or variation(s) thereof (e.g., an ABC car company entity). For example, the auto website search result 210 and the stock news search result 214, but not the car website search result 212 and the car detail website search result 216, may comprise the “engine fire recall” phrase 206 or portions/variations thereof and the ABC car company entity or portions/variations thereof. Because a relatively large number of search results may be provided by the search engine 208, if a threshold percentage (e.g., a 10% threshold) of a top number of search results (e.g., top 50 search results) comprise the “engine fire recall” phrase 206 and the ABC car company entity, then the “engine fire recall” phrase 206 may be labeled as an aspect of the car company entity 204. Otherwise, the “engine fire recall” phrase 206 may be labeled as a non-aspect of the car company entity 204. In this way, labeled phrases may be created for inclusion within the labeled training data 218. The labeled training data 218 may be used to train the entity aspect evaluation model for evaluation of phrases within social network and/or other data for determining aspects of the car company entity 204, which in turn may be used to obtain data for the aspects.

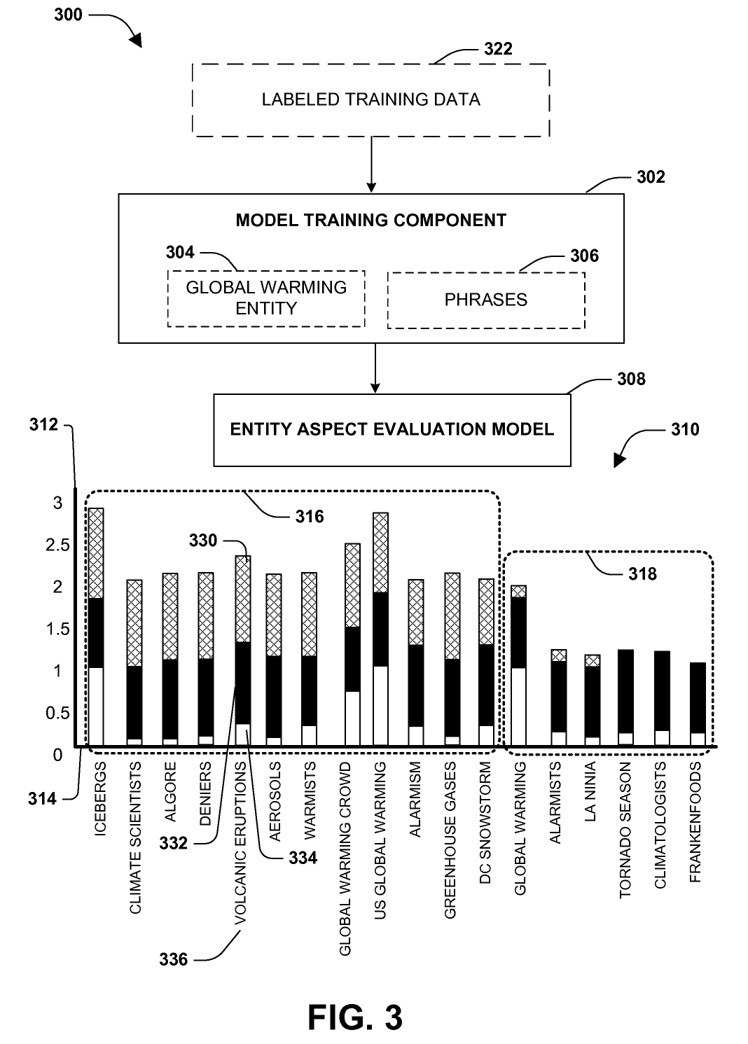

FIG. 3 illustrates an example of a system 300 for obtaining content based upon an aspect of an entity. The system 300 comprises a model training component 302. The model training component 302 may be configured to train an entity aspect evaluation model 308 for feature indicator evaluation of phrases associated with one or more phrases, such as a global warming entity 304 (e.g., trained for subsequent evaluation of phrases within social network and/or other data in order to determine aspects of the global warming entity 308). For example, the model training component 302 may train the entity aspect evaluation model 308 using labels for phrases 306 (e.g., phrases labeled as either aspects, non-aspects, likely aspects, unlikely aspects, etc. of the global warming entity 304) within labeled training data 322. The model training component 302 may utilize an Expectation-Maximization algorithm to train the entity aspect evaluation model 308 using the labeled training data 322.

The entity aspect evaluation model 308 may be trained to identify correlations between burstiness indicator information, diversity indicator information, and/or uniqueness indicator information for phrases associated with the global warming entity 304. For example, for a particular phrase, such as a “volcanic eruptions” phrase 336, burstiness indicator information, diversity indicator information, and uniqueness indicator information may provide varying degrees of accuracy in determining whether the “volcanic eruptions” phrase 336 is an aspect of the global warming entity 304. For example, burstiness (e.g., represented by checked boxes within a graph 310, such as burstiness 330 for the “volcanic eruptions” phrase 336) and diversity (e.g., represented by solid black boxes within the graph 310, such as diversity 332 for the “volcanic eruptions” phrase 336) may be relatively strong indicators as to whether the “volcanic eruptions” phrase 336 is an aspect of the global warming entity 304. However, uniqueness (e.g., represented by solid white boxes within the graph 310, such as uniqueness 334 for the “volcanic eruptions” phrase 336) may be a relatively weak indicator as to whether the “volcanic eruptions” phrase 336 is an aspect of the global warming entity 304. In this way, the entity aspect evaluation model 308 may be trained to identify and/or utilize correlations between burstiness indicator information, diversity indicator information, and uniqueness indicator information on a per-phrase basis relative to an entity.

The graph 310 may represent the labeled phrases 306 along an x-axis 314. The graph 310 may represent relative strengths of indicators being strong or weak indicators of whether a phrase is an aspect of the global warming entity 304 along a y-axis 312. The labeled training data 322 may be utilized to identify clusters of phrases having similar distributions of burstiness indicator information, diversity indicator information, and uniqueness indicator information above a similarity threshold. For example, a first cluster 316 may comprise phrases where burstiness and diversity, but not uniqueness, are relatively strong indicators as to whether such phrases are aspects of the global warming entity 304. A second cluster 318 may comprise phrases where diversity, but not burstiness or uniqueness, is a relatively strong indicator as to whether such phrases are aspects of the global warming entity 304. Such clusters may be used to train the entity aspect evaluation model 308. In this way, the labeled training data 322 may be used to train the entity aspect evaluation model 308. The trained entity aspect evaluation model may be used to determine aspects of entities, where content relevant to the entities may then be obtained based upon the aspects.

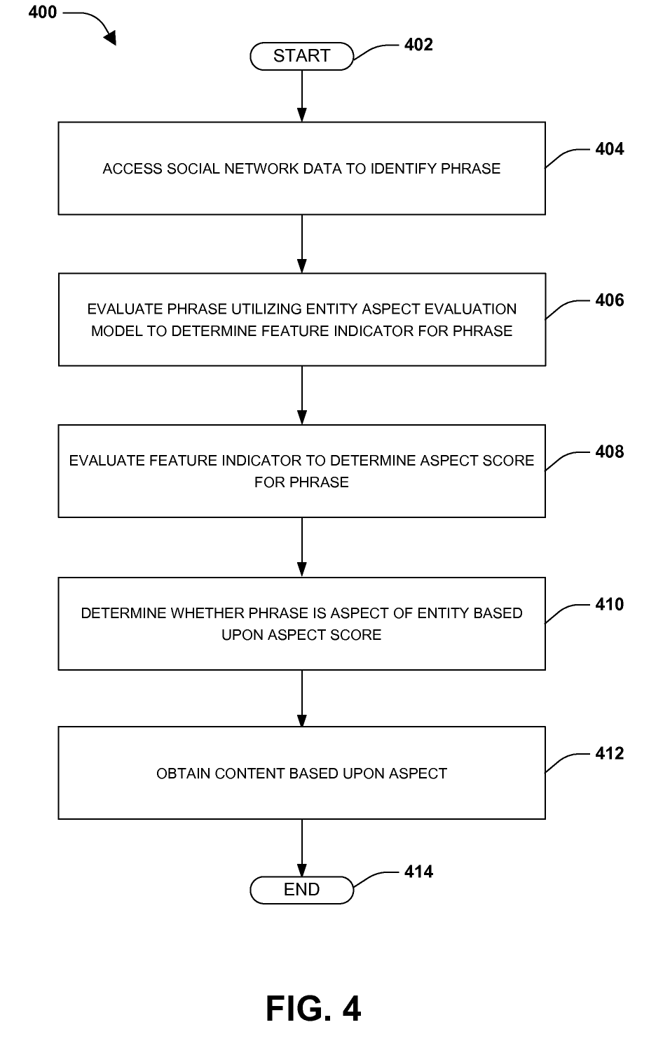

An embodiment of determining an aspect of an entity to obtain content is illustrated by an exemplary method 400 of FIG. 4. At 402, the method starts. At 404, social network data (e.g., social network posts, microblog messages, etc.) may be accessed to identify a phrase associated with an entity. In an example, a social network post, comprising the phrase and the entity (e.g., or variation(s) thereof), may be identified. The phrase may comprise any textual phrase, such as a noun phrase occurring within a threshold proximity of an adjective.

In an example, a microblog message “Did anyone read the latest perfect score review for the Hero RPG Game?!”, comprising a “perfect score review” phrase associated with a Hero RPG Game entity, may be identified. At 406, the phrase may be evaluated utilizing an entity aspect evaluation model (e.g., an entity aspect evaluation model trained using labeled training data associated with the Hero RPG Game entity) to determine a feature indicator for the phrase. The feature indicator may comprise a burstiness indicator, a diversity indicator, and/or a unique indicator for the phrase as relates to the entity.

The burstiness indicator may correspond to an increase in phrase usage within a threshold timespan (e.g., a spike in usage of the “perfect score review” phrase within a particular period of time). The diversity indicator may correspond to a number of diverse social network posts comprising the phrase (e.g., usage of the “perfect score review” phrase in many different social network posts). In an example, local sensitive hashing may be used to compute hash fingerprints of social network posts comprising the phrase. The diversity indicator may be based upon a largest subset of social network posts whose hash fingerprints are different from one another. The uniqueness indicator may correspond to a difference between and/or ratio of overall usage of the phrase in social network posts (e.g., the usage of the “perfect score review” phrase in social network posts that may or may not relate to the Hero RPG Game entity) as compared to entity related usage of the phrase in social network posts about the entity (e.g., the usage of the “perfect score review” phrase in social network posts that also comprise the Hero RPG Game entity). Generally, the more frequently a phrase occurs in a social network post along with an entity, the more likely the phrase is to be an aspect of the entity.

In an example, the feature indicator may comprise a feature indicator vector. The feature indicator vector may comprise a burstiness dimension representing the burstiness indicator, a diversity dimension representing the diversity indicator, and/or a uniqueness dimension representing the uniqueness indicator.

At 408, the feature indicator may be evaluated to determine an aspect score for the phrase. The entity aspect evaluation model may evaluate the feature indicator, such as the feature indicator vector, by applying weights to the indicators. For example, the entity aspect evaluation model may have been trained to correlate the burstiness indicator, the diversity indicator, and the uniqueness indicator for a particular phrase (e.g., the “perfect score review” phrase or a variation thereof) because certain indicators may be more or less indicative of whether the phrase is an aspect of the Hero RPG Game entity (e.g., the uniqueness indicator may be a relatively high indicator as to whether the “perfect score review” phrase is an aspect of the Hero RPG Game entity because the “perfect score review” phrase may not occur in a broad range of social network posts). In this way, an aspect score for the “perfect score review” phrase may be determined. At 410, the phrase may be determined as an aspect of the entity based upon the aspect score. For example, responsive to the aspect score exceeding a threshold, the “perfect score review” phrase may be determined as an aspect of the Hero RPG Game entity (e.g., the “perfect score review” phrase may be a trending or hot topic about the Hero RPG Game entity within social networks).

In an example where the entity comprises a consumer good entity (e.g., the Hero RPG Game entity may correspond to a Hero RPG videogame), the aspect may be used to identify a consumer preference (e.g., the aspect corresponding to the “perfect score review” phrase may indicate that the hero RPG videogame is well loved by gamers) and/or a consumer complaint (e.g., an aspect corresponding to a “game ruining glitch” phrase may indicate that the Hero RPG videogame needs an update to fix a game glitch) regarding the consumer good entity. In an example, an aspect may be used to adjust a marketing campaign for an entity (e.g., an aspect corresponding to an “all my adult gamer friends love Hero RPG” phrase may indicate that a marketing campaign for the Hero RPG Game entity may be well suited for adult gamers as opposed to merely child gamers for which the marketing campaign was originally targeted). In an example, trends of public opinions may be identified based upon aspects of an entity. For example, responsive to the “perfect score review” phrase occurring within the social network data above a trending threshold, the “perfect score review” phrase may be identified as a trend of public opinion regarding the Hero RPG Game entity.

At 412, responsive to determining that the phrase is an aspect of the entity, content is obtained based upon the aspect. For example, responsive to a search query associated with the entity, search results comprising content associated with the aspect are returned (e.g., in addition to content associated with the entity). In an example, at least some of a content provider (e.g., a server that may provide content through emails, a website, a search engine, an application, a map interface, a recommendation service, etc.) may be local to and/or remote from a user device and may provide content (e.g., that is temporally relevant, etc.) to the user device based upon the aspect of the entity. In an example, a search is directed towards content sources associated with the aspect of the entity to obtain relevant content, and thereby conserve resources. At 414, the method ends.

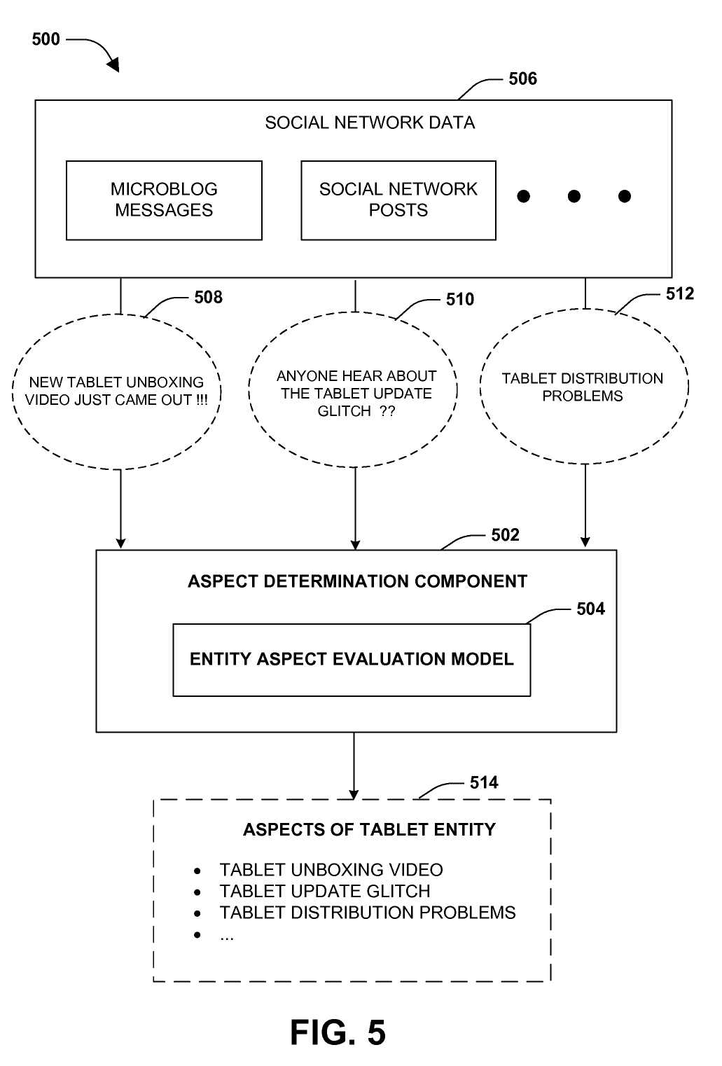

FIG. 5 illustrates an example of a system 500 for obtaining content based upon an aspect of an entity. The system 500 comprises an aspect determination component 502. The aspect determination component 502 may be configured to evaluate social network data 506 to identify phrases associated with an entity, such as a Tablet entity. For example, the aspect determination component 502 may identify a first phrase “Tablet unboxing video” from a first social network post 508 “New Tablet unboxing video just came out !!!!”, a second phrase “Tablet update glitch” from a second social network post 510 “anyone hear about the Tablet update glitch ??”, a third phrase “Tablet distribution problems” from a third social network post 512 “Tablet distribution problems”, and/or other phrases associated with the Tablet entity.

The aspect determination component 502 may evaluate the phrases utilizing an entity aspect evaluation model 504 to determine feature indicators for the phrases, where the entity aspect evaluation model 504 is trained using training data for the entity. For example, a first burstiness indicator, a first diversity indicator, and/or a first uniqueness indicator may be identified for the first phrase, which may be assigned weights based upon how indicative such indicators are as to whether the first phrase is an aspect of the Tablet entity. A second burstiness indicator, a second diversity indicator, and/or a second uniqueness indicator may be identified for the second phrase, which may be assigned weights based upon how indicative such indicators are as to whether the second phrase is an aspect of the Tablet entity. A third burstiness indicator, a third diversity indicator, and/or a third uniqueness indicator may be identified for the third phrase, which may be assigned weights based upon how indicative such indicators are as to whether the third phrase is an aspect of the Tablet entity.

The feature indicators may be evaluated to determine aspect scores for the phrases. Phrases having aspects scores above a threshold may be determined as aspects 514 of the Tablet entity. For example, the first phrase “Tablet unboxing video”, the second phrase “Tablet update glitch”, the third phrase “Tablet distribution problems”, and/or other phrases may be determined as aspects of the Tablet entity. However, other phrases having aspects scores not above the threshold are not regarded as aspects of the Tablet entity. Because the aspects are related or correlated to the Tablet entity, as determined by the trained entity aspect evaluation model, the aspects in obtaining content regarding the entity.

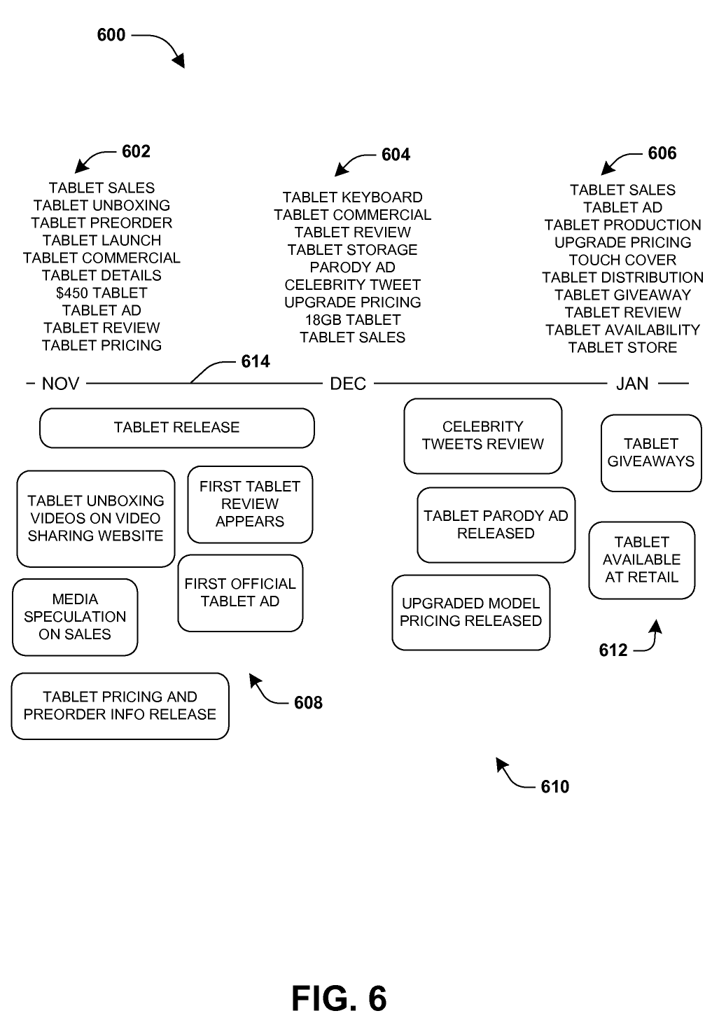

FIG. 6 illustrates an example 600 of aspects identified for a Tablet entity, such as according to the foregoing discussion. The aspects are displayed above a timeline 614 spanning from November to January. A first set of aspects 602, such as a Tablet sales aspect, a Tablet unboxing aspect, a Tablet preorder aspect, a Tablet launch aspect, a Tablet commercial aspect, a Tablet details aspect, a $450 Tablet aspect, a Tablet AD aspect, a Tablet review aspect, and a Tablet pricing aspect, may have been identified based upon phrases of social network data occurring in November. The first set of aspects 602 may correspond to a first set of events 608 occurring within November, such as a Tablet release event, the availability of Tablet unboxing videos through a video sharing website, media speculation on sales, release of Tablet pricing and preorder info, an appearance of a first review for the Tablet, a first official Tablet AD, etc.

A second set of aspects 604, such as a Tablet keyboard aspect, the Tablet commercial aspect, the Tablet review aspect, a Tablet storage aspect, a parody AD aspect, a celebrity tweet aspect, an upgrade pricing aspect, an 18 GB Tablet aspect, and the Tablet sales aspect, may have been identified based upon phrases of social network data occurring in December. The second set of aspects 604 may correspond to a second set of events 610 occurring in December, such as a celebrity tweeting a review for the Tablet entity, a Tablet parody AD being released, a release of upgraded model pricing, rumors circulating about a 7-inch Tablet for gamers, etc.

A third set of aspects 606, such as the Tablet sales aspect, the Tablet AD aspect, a Tablet production aspect, the upgrade pricing aspect, a touch cover aspect, a Tablet distribution aspect, a Tablet giveaway aspect, the Tablet review aspect, a Tablet availability aspect, and a Tablet store aspect, may have been identified based upon phrases of social network data occurring in January. The third set of aspects 606 may correspond to a third set of events 612 occurring in January, such as Tablet giveaways and the Tablet becoming availability at retail stores.

It is to be appreciated that the aspects for the Tablet entity change over time, such that the first set of aspects 602, the second set of aspects 604 and the third set of aspects are not identical. In this manner, content obtained based upon the aspects will likewise evolve over time. For example, a search query for the Tablet entity in December may result in content being provided based upon the celebrity tweet aspect, whereas such content has little to no likelihood of being provided for the same search query in January. Accordingly, temporally relevant content may be obtained and provided to a user (e.g., displayed on a device of the user).

According to an aspect of the instant disclosure, a system for obtaining content based upon an aspect of an entity is provided. The system includes an aspect determination component. The aspect determination component is configured to identify a first phrase associated with an entity. The aspect determination component is configured to evaluate the first phrase utilizing an entity aspect evaluation model, that is trained, to determine whether the first phrase is an aspect of the entity. The aspect determination component is configured to, responsive to determining that the first phrase is an aspect of the entity, obtain content based upon the aspect.

According to an aspect of the instant disclosure, a method for obtaining content based upon an aspect of an entity is provided. The method includes accessing social network data to identify a phrase. The method includes evaluating the phrase utilizing an entity aspect evaluation model, that is trained, to determine a feature indicator for the phrase. The feature indicator comprises at least one of a burstiness indicator, a diversity indicator, or a uniqueness indicator for the phrase as relates to an entity. The method includes evaluating the feature indicator to determine an aspect score for the phrase. The method includes determining whether the phrase is an aspect of the entity based upon the aspect score. The method includes, responsive to determining that the phrase is an aspect of the entity, obtaining content based upon the aspect.

According to an aspect of the instant disclosure, a method for obtaining content based upon an aspect of an entity is provided. The method includes obtaining content based upon an aspect of an entity, where the aspect is identified using an entity aspect evaluation model, that is trained, to evaluate a first phrase associated with the entity to determine whether the first phrase is an aspect of the entity.

According to an aspect of the instant disclosure, a means for obtaining content based upon an aspect of an entity is provided. A first phrase associated with an entity is identified, by the means for obtaining content. The first phrase is evaluated utilizing an entity aspect evaluation model, that is trained, to determine whether the first phrase is an aspect of the entity, by the means for obtaining content. Responsive to determining that the first phrase is an aspect of the entity, content is obtained based upon the aspect, by the means for obtaining content.

According to an aspect of the instant disclosure, a means for obtaining content based upon an aspect of an entity is provided. Social network data is accessed to identify a phrase, by the means for obtaining content. The phrase is evaluated utilizing an entity aspect evaluation model, that is trained, to determine a feature indicator for the phrase, by the means for obtaining content. The feature indicator comprises at least one of a burstiness indicator, a diversity indicator, or a uniqueness indicator for the phrase as relates to the entity. The feature indicator is evaluated to determine an aspect score for the phrase, by the means for obtaining content. A determination is made as to whether the phrase is an aspect of the entity based upon the aspect score, by the means for obtaining content.

Responsive to determining that the phrase is an aspect of the entity, content is obtained based upon the aspect, by the means for obtaining content.

According to an aspect of the instant disclosure, a means for obtaining content based upon an aspect of an entity is provided. Content is obtained based upon an aspect of an entity, by the means for obtaining content, where the aspect is identified using an entity aspect evaluation model, that is trained, to evaluate a first phrase associated with the entity to determine whether the first phrase is an aspect of the entity.

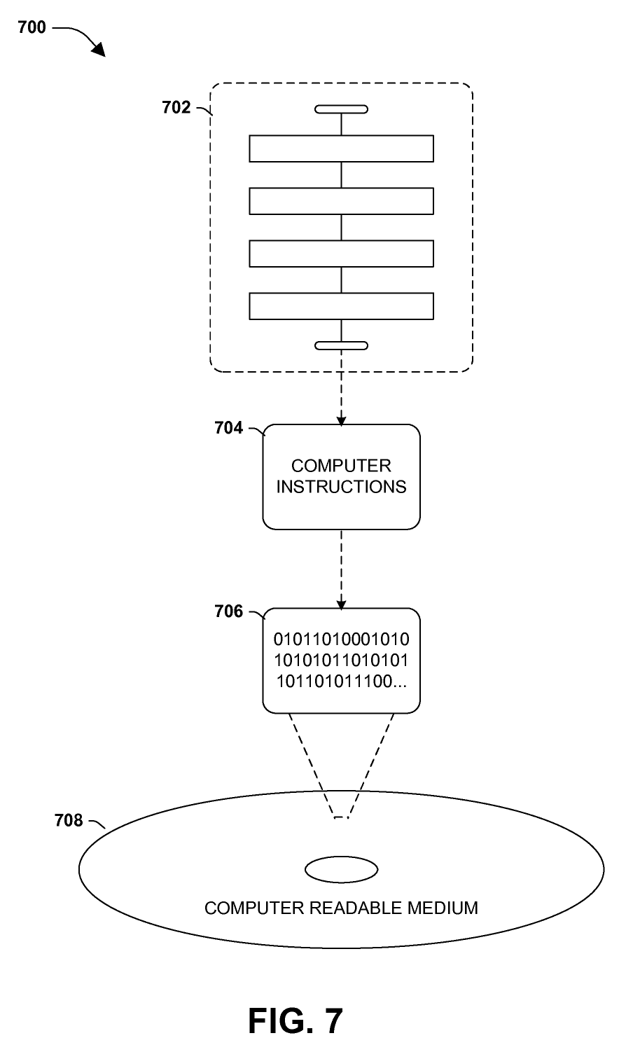

Still another embodiment involves a computer-readable medium comprising processor-executable instructions configured to implement one or more of the techniques presented herein. An example embodiment of a computer-readable medium or a computer-readable device is illustrated in FIG. 7, wherein the implementation 700 comprises a computer-readable medium 708, such as a CD-R, DVD-R, flash drive, a platter of a hard disk drive, etc., on which is encoded computer-readable data 706. This computer-readable data 706, such as binary data comprising at least one of a zero or a one, in turn comprises a set of computer instructions 704 configured to operate according to one or more of the principles set forth herein. In some embodiments, the processor-executable computer instructions 704 are configured to perform a method 702, such as at least some of the exemplary method 100 of FIG. 1 and/or at least some of the exemplary method 400 of FIG. 4, for example. In some embodiments, the processor-executable instructions 704 are configured to implement a system, such as at least some of the exemplary system 200 of FIG. 2, at least some of the exemplary system 300 of FIG. 3, and/or at least some of the exemplary system 500 of FIG. 5, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

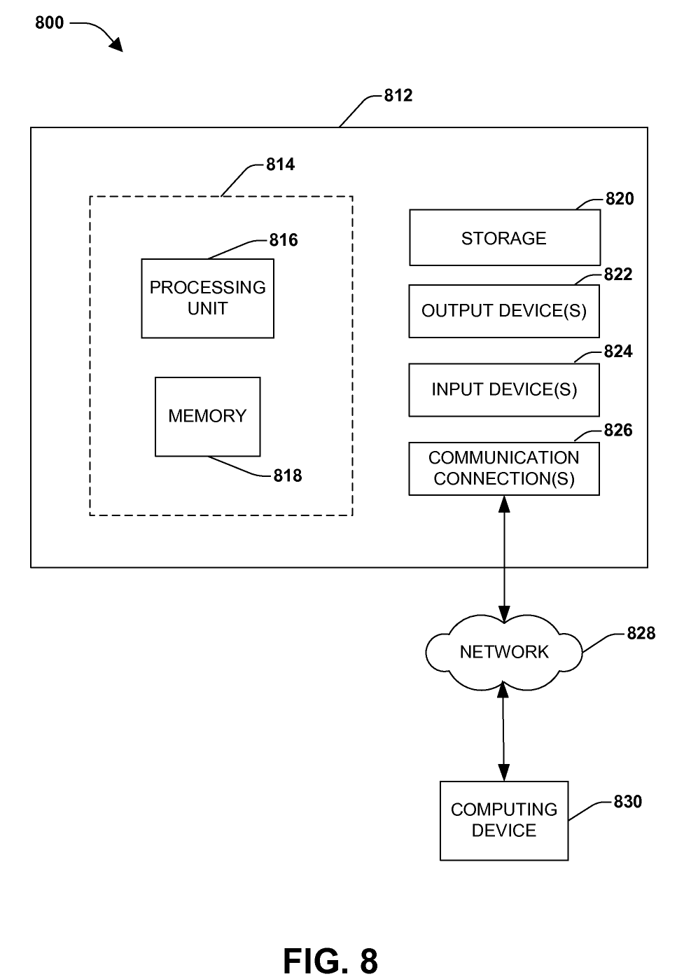

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Computer storage media does not, however, include propagated signals. Rather, computer storage media excludes propagated signals. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via a network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B.

Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system for obtaining content based upon an aspect of an entity, comprising:
one or more processing units; and
memory comprising instructions that when executed by at least one of the one or more processing units implement at least some of:
an aspect determination component configured to:
identify a first phrase associated with an entity;
evaluate the first phrase utilizing an entity aspect evaluation model, that is trained, to determine whether the first phrase is an aspect of the entity; and
responsive to determining that the first phrase is an aspect of the entity, obtain content based upon the aspect.

2. The system of claim 1, the instructions when executed implement:
a model training component configured to:
identify the entity;
obtain labeled training data comprising labels for phrases associated with the entity; and
utilize the labeled training data to train the entity aspect evaluation model for feature indicator evaluation of phrases, the entity aspect evaluation model trained based upon at least one of burstiness indicator information, diversity indicator information, or uniqueness indicator information for a phrase as relates to the entity, the burstiness indicator information corresponding to an increase in phrase usage within a threshold timespan, the diversity indicator information corresponding to a number of diverse social network posts comprising the phrase, and the uniqueness indicator information corresponding to a difference between overall usage of the phrase and entity related usage of the phrase.

3. A method for obtaining content based upon an aspect of an entity, comprising:
accessing social network data to identify a phrase;
evaluating the phrase utilizing an entity aspect evaluation model, that is trained, to determine a feature indicator for the phrase, the feature indicator comprising at least one of a burstiness indicator, a diversity indicator, or a uniqueness indicator for the phrase as relates to an entity;
evaluating the feature indicator to determine an aspect score for the phrase;
determining whether the phrase is an aspect of the entity based upon the aspect score; and
responsive to determining that the phrase is an aspect of the entity, obtaining content based upon the aspect.

4. The method of claim 3, the feature indicator comprising a feature indicator vector, the feature indicator vector comprising a burstiness dimension, a diversity dimension, and a uniqueness dimension.

5. The method of claim 3, the accessing social network data comprising:
identify a social network post comprising the phrase.

6. The method of claim 3, the burstiness indicator corresponding to an increase in phrase usage within a threshold timespan.

7. The method of claim 3, the diversity indicator corresponding to a number of diverse social network posts comprising the phrase.

8. The method of claim 3, the uniqueness indicator corresponding to a difference between overall usage of the phrase and entity related usage of the phrase.

9. The method of claim 3, the entity comprising a consumer good entity, and the obtaining content comprising:
identifying at least one of consumer preference or a consumer complaint regarding the consumer good entity.

10. The method of claim 3, comprising:
responsive to determining that the phrase is an aspect of the entity, adjusting a marketing campaign for the entity based upon the aspect.

11. The method of claim 3, comprising:
responsive to determining that the phrase is an aspect of the entity, identifying a trend of public opinion regarding the entity based upon the aspect.

12. A computer readable medium comprising instructions which when executed perform a method for obtaining content based upon an aspect of an entity, comprising:
obtaining content based upon an aspect of an entity, the aspect identified using an entity aspect evaluation model, that is trained, to evaluate a first phrase associated with the entity to determine whether the first phrase is an aspect of the entity.

13. The computer readable medium of claim 12, the method comprising:
identifying the entity;
obtaining labeled training data comprising labels for phrases associated with the entity;
utilizing the labeled training data to train the entity aspect evaluation model for feature indicator evaluation of phrases, the entity aspect evaluation model trained based upon at least one of burstiness indicator information, diversity indicator information, or uniqueness indicator information for a phrase as relates to the entity.

14. The computer readable medium of claim 13, the obtaining labeled training data comprising:
submitting a phrase as a query to a search engine; and
responsive to a threshold percentage of search result descriptions comprising the phrase and an entity identifier of the entity, labeling the phrase as an aspect for the entity, otherwise labeling the phrase as a non-aspect for the entity, to create a labeled phrase for inclusion within the labeled training data.

15. The computer readable medium of claim 13, the utilizing the labeled training data comprising:
performing an Expectation-Maximization algorithm to train the entity aspect evaluation model.

16. The computer readable medium of claim 13, the utilizing the labeled training data comprising:
identifying a first cluster of phrases having a first distribution of burstiness indicator information, diversity indicator information, and uniqueness indicator information above a similarity threshold.

17. The computer readable medium of claim 16, the utilizing the labeled training data comprising:
identifying a second cluster of phrases having a second distribution of burstiness indicator information, diversity indicator information, and uniqueness indicator information above the similarity threshold.

18. The computer readable medium of claim 13, the burstiness indicator information corresponding to an increase in phrase usage within a threshold timespan.

19. The computer readable medium of claim 13, the diversity indicator information corresponding to a number of diverse social network posts comprising the phrase.

20. The computer readable medium of claim 13, the uniqueness indicator information corresponding to a difference between overall usage of the phrase and entity related usage of the phrase.
